(19) United States
(12) Patent Application Publication
(10) Pub. No.: US 2014/0169692 A1
(43) Pub. Date: Jun. 19, 2014

(54) CLIENT DEVICE AND METHOD FOR ENCODING AND TRANSMITTING PICTURE TO CLIENT DEVICE

(71) Applicant: HON HAI PRECISION INDUSTRY CO., LTD., New Taipei (TW)

(72) Inventors: CHIH-YEN LIN, New Taipei (TW); TSUNG-HSIN YEN, New Taipei (TW); CHIEN-FA YEH, New Taipei (TW); CHUNG-I LEE, New Taipei (TW)

(73) Assignee: HON HAI PRECISION INDUSTRY CO., LTD., New Taipei (TW)

(21) Appl. No.: 14/060,724

(22) Filed: Oct. 23, 2013

(30) Foreign Application Priority Data
Dec. 19, 2012 (TW) 101148531

(51) Int. Cl. H04N 19/112; H04N 19/164

(52) U.S. Cl. CPC H04N 19/00048; H04N 19/00236
USPC 382/239

(57) ABSTRACT

In a method for encoding and transmitting a picture to a client device, data of a picture is encoded by a progressive encoding method on a server and stored in a buffer of the server, and an amount of data of the picture transmitted to the client device at a time is determined according to a kind of the progressive encoding method. The amount of the data transmitted to the client device at a time is reduced if a current window size is not equal to or larger than a last window size, and is increased if the current window size is equal to or larger than the last window size. The data is transmitted from the server, and decoded and displayed on the client device.

### BACKGROUND

1. Technical Field

The embodiments of the present disclosure relate to a client device and method for encoding and transmitting a picture to the client device.

2. Description of Related Art

Popular encoding methods may comprise a progressive coding method. The progressive encoding method transmits a general outline of a picture from a server to a client device, thereafter transmits details of the picture to the client device gradually, making the picture is decoded and displayed on the client device from a blurry picture to clear picture gradually. Because the progressive encoding method can only transmit a certain amount of data to the client device at a time, the progressive encoding method cannot display a high-definition picture when a network bandwidth between the server and the client device can support larger amounts of data transmission.

### BRIEF DESCRIPTION OF THE DRAWINGS

FIG. 1 is a block diagram of one embodiment of a client device including an encoding and transmission system.

FIG. 2 is a block diagram of one embodiment of function modules of the encoding and transmission system in FIG. 1.

FIG. 3 is a flowchart of one embodiment of a method for encoding and transmitting a picture to the client device of FIG. 1.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean “at least one.”

In general, the word “module,” as used herein, refers to logic embodied in hardware or firmware, or to a collection of software instructions, written in a programming language. In one embodiment, the program language may be Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media include CDs, DVDs, flash memory, and hard disk drives.

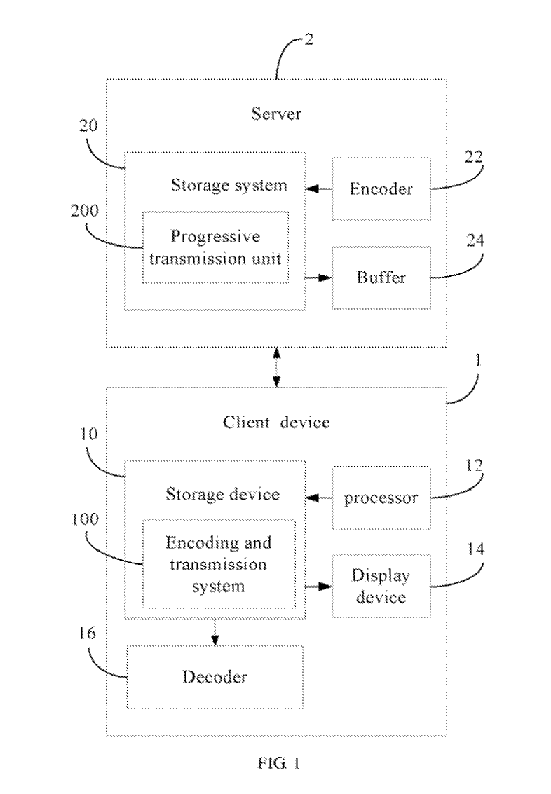

FIG. 1 is a block diagram of one embodiment of a client device 1 including an encoding and transmission system 100. The client device 1 includes a storage device 10, at least one processor 12, a display device 14, and a decoder 16. The client device 1 connects to a server 2 through a network complying with a Transmission Control Protocol (TCP). The server 2 comprises a storage system 20, an encoder 22, and a buffer 24. The client device 1 may be a personal computer, a notebook computer, a cellular phone, or a personal digital assistant (PDA), for example.

The storage device 10 (non-transitory storage device) and the storage system 20 may be internal storage systems, such as random access memories (RAMs) for the temporary storage of information, and/or a read only memories (ROMs) for the permanent storage of information. The storage device 10 and the storage system 20 may be external storage systems, such as external hard disks, storage cards, or data storage mediums. The storage system 20 further comprises a progressive transmission unit 200. The progressive transmission unit 200 provides a transmission port between the server 2 and the client device 1. Data of a picture on the server 2 is encoded and stored in the buffer 24, and is transmitted through the transmission port of the progressive transmission unit 200 to the client device 1.

The at least one processor 12 may include a processor unit, a microprocessor, an application-specific integrated circuit, and a field programmable gate array.

The decoder 16 decodes the data of the picture transmitted from the server 2, and the display device 14 displays the decoded data of the picture on the client device 1 to show the user.

In one embodiment, the encoding and transmission system 100 includes a plurality of function modules that include computerized codes or instructions that can be stored in the storage device 10 and executed by the at least one processor 12 to provide a method for encoding and transmitting a picture to the client device 1.

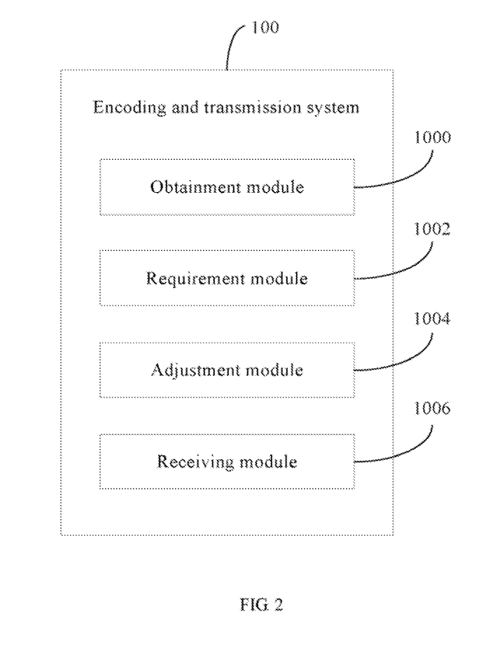

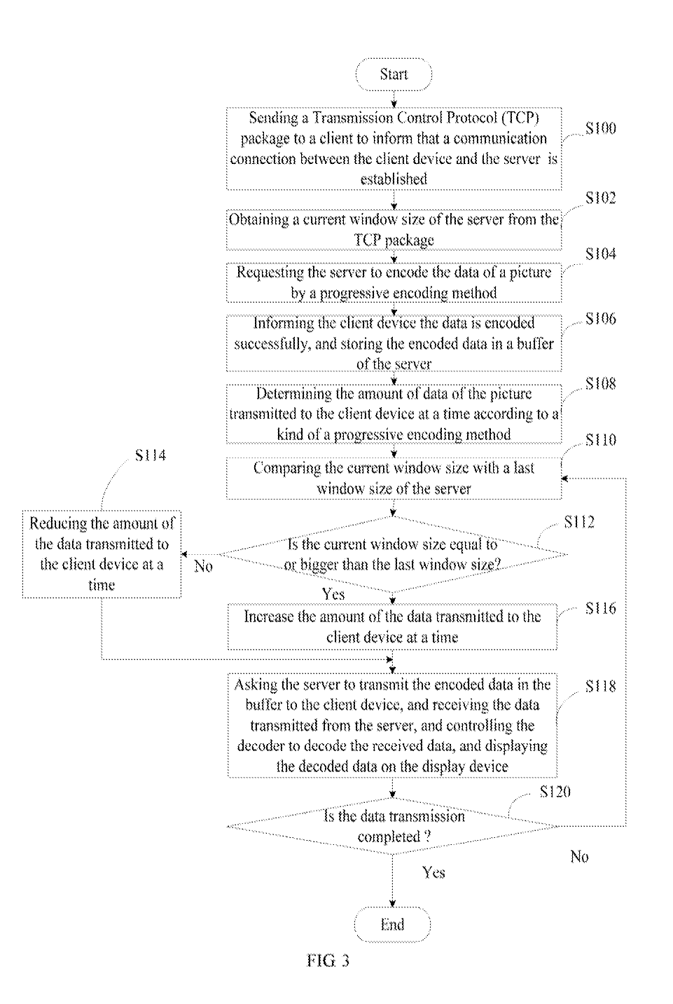

FIG. 2 is a block diagram of one embodiment of function modules of the encoding and transmission system 100. In the embodiment, the encoding and transmission system 100 includes an obtainment module 1000, a requirement module 1002, an adjustment module 1004, and a receiving module 1006. The modules may comprise computerized codes in the form of one or more programs that are stored in the storage device 10 and executed by the at least one processor 12 to provide functions for implementing the encoding and transmission system 100. The functions of the function modules are illustrated in FIG. 3 and described below.

FIG. 3 illustrates a flowchart of one embodiment of a method for encoding and transmitting a picture to the client device 1. Depending on the embodiment, additional steps may be added, others removed, and the ordering of the steps may be changed.

In step S100, the progressive transmission unit 200 establishes a communication connection between the client device 1 and the server 2 and sends a TCP package to the client device 1 to inform the client device 1 that the communication connection between the client device 1 and the server 2 is established successfully. In one embodiment, the TCP package comprises a current window size of the server 2. The data of the picture is transmitted to the client device 1 by more than one time, the window size defined an amount of data transmitted to the client device 1 at a time, and is determined by a network bandwidth between the server 2 and the client device 1. The current window size defines the amount of data transmitted to the client device 1 at a specific time.

In step S102, the obtainment module 1000 obtains the current window size of the server 2 from the TCP package and saves the current window size in the storage device 10.

In step S104, the requirement module 1002 requests the server 2 to encode the data of the picture by a progressive encoding method. In the embodiment, the data is encoded by the encoder 22 of the server 2, and the encoded data is in a form of a TCP package.

In step S106, the server 2 informs the client device 1 that the data is encoded successfully and stores the encoded data in the buffer 24.

In step S108, the adjustment module 1004 determines the amount of data of the picture transmitted to the client device 1 at a time according to a kind of the progressive encoding method. In the embodiment, the progressive encoding method usually comprises a first progressive encoding method and a second progressive encoding method. The first kind progressive encoding method divides the picture into bit planes, the adjustment module 1004 determines how many bit planes transmitted to the client device 1 at a time. The second progressive encoding method transforms the picture by a discrete cosine transform method, the adjustment module 1004 determines how many coefficients generated during the discrete cosine transform transmitted to the client device 1 at a time.

In step S110, the adjustment module 1004 compares the current window size with a last window size of the server 2.

In step S112, the adjustment module 1004 determines whether the current window size is equal to or larger than the last window size. In the embodiment, the last window size defined the amount of data transmitted to the client device 1 last time. If the current window size is equal to or larger than the last window size, step S116 is implemented. Otherwise, if the current window size is not equal to or larger than the last window size, step S114 is implemented.

In step S114, the adjustment module 1004 reduces the amount of the data transmitted to the client device 1 at a time, and the process goes to step S118.

In step S116, the adjustment module 1004 increases the amount of the data transmitted to the client device 1 at a time, and the process goes to step S118. For example, if the current window size is equal to or larger than the last window size, the network bandwidth between the client device 1 and the server 2 can support a larger amounts of data transmission, the client device 1 can request the server 2 for more bit planes at a time.

In step S118, the receiving module 1006 requests the server 2 to transmit the encoded data in the buffer 24 of the server 2, receives the data transmitted from the server 2, controls a decoder 16 of the client device 1 to decode the data, and displays the decoded data on the display device 14 of the client device 1.

In step S120, the receiving module 1006 determines whether the data transmission is completed according to the amount of the received data and the requested data. If the data transmission is not completed, the process returns to step S110. Otherwise, if the data transmission is completed, the process ends.

Although certain disclosed embodiments of the present disclosure have been specifically described, the present disclosure is not to be construed as being limited thereto. Various changes or modifications may be made to the present disclosure without departing from the scope and spirit of the present disclosure.

What is claimed is:

1. A client device, comprising:
at least one processor; and
a storage device storing a computer program including instructions that, which executed by the at least one processor, causes the at least one processor to:
obtain a current window size of a server connected to the client device;
request the server to encode data of the picture by a progressive encoding method, and store the encoded data in a buffer of the server;
determine an amount of data of the picture transmitted to the client device at a time according to the progressive encoding method;
compare the current window size with a last window size of the server, and determine whether the current window size is equal to or larger than the last window size;
reduce the amount of the data transmitted to the client device at a time if the current window size is not equal to or larger than the last window size;
increase the amount of the data transmitted to the client device at a time if the current window size is equal to or larger than the last window size;
request the server to transmit the encoded data in the buffer of the server; and
receive the data transmitted from the server, and control a decoder of the client to decode the data, and display the decoded data on a display device of the client device.

2. The client device according to claim 1, wherein the data of the picture is encoded by an encoder of the server.

3. The client device according to claim 1, wherein the server comprises a progressive transmission unit that sends a transmission control protocol (TCP) package comprising the current window size of the server to the client device to inform that a communication connection between the client device and the server is established successfully, and transmits the encoded data stored in the buffer of the server to the client device through a transmission port.

4. The client device according to claim 1, wherein the progressive encoding method comprises a first progressive encoding method and a second progressive encoding method.

5. The client device according to claim 4, wherein the first progressive encoding method divides the picture into bit planes and transmits the bit plane to the client device at a time.

6. The client device according to claim 4, wherein the second progressive encoding method transforms the picture by a discrete cosine transform method and transmits the coefficients generated by the discrete cosine transform.

7. A method for encoding and transmitting a picture to a client device, the method comprising:
obtaining a current window size of a server connected to the client device;
requesting the server to encode data of the picture by a progressive encoding method, and storing the encoded data in a buffer of the server;
determining an amount of data of the picture transmitted to the client at a time according to the progressive encoding method;
comparing the current window size with a last window size of the server, and determining whether the current window size is equal to or larger than the last window size;
reducing the amount of the data transmitted to the client device at a time if the current window size is not equal to or larger than the last window size;
increasing the amount of the data transmitted to the client device at a time if the current window size is equal to or larger than the last window size;
requesting the server to transmit the encoded data in the buffer of the server; and
receiving the data transmitted from the server, and controlling a decoder of the client device to decode the data, and displaying the decoded data on a display device of the client device.

8. The method according to claim 7, wherein the data of the picture is encoded by an encoder of the server.

9. The method according to claim 7, wherein the server comprises a progressive transmission unit that sends a transmission control protocol (TCP) package comprising the current window size of the server to the client to inform that a communication connection between the client device and the server is established successfully, and transmits the encoded data stored in the buffer of the server to the client device through a transmission port.

10. The method according to claim 7, wherein the progressive encoding method comprises a first progressive encoding method and a second progressive encoding method.

11. The method according to claim 10, wherein the first progressive encoding method divides the picture into bit planes and transmits the bit plane to the client at a time.

12. The method according to claim 10, the second progressive encoding method transforms the picture by a discrete cosine transform method and transmits the coefficients generated by the discrete cosine transform.

13. A non-transitory computer-readable storage medium having stored thereon instructions being executed by a processor of a client device, causes the processor to perform a method for encoding and transmitting a picture to the client device, the method comprising:
obtaining a current window size of a server connected to the client;
requesting the server to encode data of the picture by a progressive encoding method, and storing the encoded data in a buffer of the server;
determining an amount of data of the picture transmitted to the client device at a time according to the progressive encoding method;
comparing the current window size with a last window size of the server, and determining whether the current window size is equal to or larger than the last window size;
reducing the amount of the data transmitted to the client device at a time if the current window size is not equal to or larger than the last window size;
increasing the amount of the data transmitted to the client device at a time if the current window size is equal to or larger than the last window size;
requesting the server to transmit the encoded data in the buffer of the server; and
receiving the data transmitted from the server, controlling a decoder of the client device to decode the data, and displaying the decoded data on a display device of the client.

14. The storage medium according to claim 13, wherein the data of the picture is coded by an encoder of the server.

15. The storage medium according to claim 13, wherein the server comprises a progressive transmission unit that sends a transmission control protocol (TCP) package comprising the current window size of the server to the client to inform that a communication connection between the client device and the server is established successfully, and transmits the encoded data stored in the buffer of the server to the client device through a transmission port.

16. The storage medium according to claim 13, wherein the progressive encoding method comprises a progressive encoding method and a second progressive encoding method.

17. The storage medium according to claim 16, wherein the first progressive encoding method divides the picture into bit planes and transmits the bit plane to the client device at a time.

18. The storage medium according to claim 16, the second progressive encoding method transforms the picture by a discrete cosine transform method and transmits the coefficients generated by the discrete cosine transform.
